(19) United States
(12) Patent Application Publication
(10) Pub. No.: US 2020/0004448 A1
(43) Pub. Date: Jan. 2, 2020

(54) DATA STORAGE SYSTEM DIE SET MAPPING

(71) Applicant: Seagate Technology LLC, Cupertino, CA (US)

(72) Inventors: Stacey Secatch, Niwot, CO (US); Steven S. Williams, Longmont, CO (US); David W. Claude, Loveland, CO (US); Benjamin J. Scott, Longmont, CO (US); Kyumsung Lee, Louisville, CO (US); Jeff Rogers, Dunlap, IL (US)

(73) Assignee: Seagate Technology LLC

(21) Appl. No.: 16/021,134

(22) Filed: Jun. 28, 2018

(51) Int. Cl. G06F 3/06

(52) U.S. Cl. CPC G06F 3/0644; G06F 3/0679; G06F 3/0604

(57) ABSTRACT

A data storage system can arrange semiconductor memory into a plurality of die sets that each store a top-level map with each top-level map logging information about user-generated data stored in a die set in which the top-level map is stored. A journal can be stored in at least one die set of the plurality of die sets with each journal logging a change to user-generated data stored in the die set of the plurality of die sets in which the journal and top-level map are each located.

### SUMMARY

Various embodiments of the present disclosure are generally directed to the mapping of data access operations to a memory, such as, but not limited to, a flash memory in a solid state drive (SSD).

In accordance with some embodiments, a data storage system has a semiconductor memory into a plurality of die sets that each store a top-level map with each top-level map logging information about user-generated data stored in a die set in which the top-level map is stored. A journal can be stored in at least one die set of the plurality of die sets with each journal logging a change to user-generated data stored in the die set in which the journal and top-level map are each located.

A data storage system, in various embodiments, divides a semiconductor memory into a plurality of logical die sets prior to storing a top-level map in each of the plurality of die sets with each top-level map logging information about user-generated data stored in a die set in which the top-level map is stored. A journal is then stored in at least one die set of the plurality of die sets with each journal logging a change to user-generated data stored in the die set in which the journal and top-level map are each located.

Other embodiments divide a semiconductor memory into a first die set and a second die set where separate map structures are respectively stored. Storing a first user-generated data to the first die set precedes logging the first user-generated data in a top-level map stored in the first die set. An update the first user-generated data is written to the first die set and a journal is subsequently generated and stored in the first die set with the journal supplementing the top-level map with information about the updated first user-generated data.

These and other features which may characterize various embodiments can be understood in view of the following detailed discussion and the accompanying drawings.

### BRIEF DESCRIPTION OF THE DRAWINGS

FIG. 1 provides a functional block representation of a data storage device in accordance with various embodiments.

FIG. 2 shows aspects of the device of FIG. 1 characterized as a solid state drive (SSD) in accordance with some embodiments.

FIG. 3 is an arrangement of the flash memory of FIG. 2 in some embodiments.

FIG. 4 illustrates the use of channels to access the dies in FIG. 3 in some embodiments.

FIG. 5 represents a map unit (MU) as a data arrangement stored to the flash memory of FIG. 2.

FIG. 6 shows a functional block diagram for a GCU management circuit of the SSD in accordance with some embodiments.

FIG. 7 illustrates an arrangement of various GCUs and corresponding tables of verified GCUs (TOVGs) for a number of different die sets in some embodiments.

FIG. 8 displays a functional block diagram for a GCU management circuit of the SSD in accordance with some embodiments.

FIG. 9 depicts an arrangement of various GCUs and corresponding tables of verified GCUs (TOVGs) for a number of different die sets in some embodiments.

FIG. 10 illustrates an example data set that can be written to the data storage device of FIG. 1 in accordance with assorted embodiments.

FIG. 11 conveys a block representation of an example data storage system in which various embodiments may be practiced.

FIG. 12 represents portions of an example data storage system configured in accordance with various embodiments.

FIG. 13 conveys an example initialization process that can be carried out by various embodiments.

FIG. 14 is an example mapping routine that can be executed by the respective embodiments of FIGS. 1-13.

### DETAILED DESCRIPTION

Without limitation, the various embodiments disclosed herein are generally directed to mapping data accesses to different die set portions a data storage system to provide optimized system power up initialization.

Solid state drives (SSDs) are data storage devices that store user data in non-volatile memory (NVM) made up of an array of solid-state semiconductor memory cells. SSDs usually have an NVM module and a controller. The controller controls the transfer of data between the NVM and a host device. The NVM will usually be NAND flash memory, but other forms of solid-state memory can be used.

A flash memory module may be arranged as a series of dies. A die represents a separate, physical block of semiconductor memory cells. The controller communicates with the dies using a number of channels, or lanes, with each channel connected to a different subset of the dies. Any respective numbers of channels and dies can be used. Groups of dies may be arranged into die sets, which may correspond with the NVMe (Non-Volatile Memory Express) Standard. This standard enables multiple owners (users) to access and control separate portions of a given SSD (or other memory device).

Metadata is often generated and used to describe and control the data stored to an SSD. The metadata may take the form of one or more map structures that track the locations of data blocks written to various GCUs (garbage collection units), which are sets of erasure blocks that are erased and allocated as a unit. The map structures can include a top-level map and a number of journal updates to the top-level map, although other forms can be used.

The top-level map provides an overall map structure that can be accessed by a controller to service a received host access command (e.g., a write command, a read command, etc). The top-level map may take the form of a two-tier map, where a first tier of the map maintains the locations of map pages and a second tier of the map provides a flash transition layer (FTL) to provide association of logical addresses of the data blocks to physical addresses at which the blocks are stored. Other forms of maps can be used including single tier maps and three-or-more tier maps, but each generally provides a forward map structure in which pointers may be used to point to each successive block until the most current version is located.

A reverse directory can be written to the various GCUs and provides local data identifying, by logical address, which data blocks are stored in the associated GCU. The reverse directory, also sometimes referred to as a footer, thus provides a physical to logical association for the locally stored blocks. As with the top-level map, the reverse directory can take any number of suitable forms. Reverse directories are particularly useful during garbage collection operations, since a reverse directory can be used to determine which data blocks are still current and should be relocated before the associated erasure blocks in the GCU are erased.

SSDs expend a significant amount of resources on maintaining accurate and up-to-date map structures. Nevertheless, it is possible from time to time to have a mismatch between the forward map and the reverse directory for a given GCU. These situations are usually noted at the time of garbage collection. For example, the forward map may indicate that there are X valid data blocks in a given erasure block (EB), but the reverse directory identifies a different number Y valid blocks in the EB. When this type of mismatch occurs, the garbage collection operation may be rescheduled or may take a longer period of time to complete while the system obtains a correct count before proceeding with the recycling operation.

The NVMe specification provides that a storage device should have the ability to provide guaranteed levels of deterministic performance for specified periods of time (deterministic windows, or DWs). To the extent that a garbage collection operation is scheduled during a DW, it is desirable to ensure that the actual time that the garbage collection operation would require to complete is an accurate estimate in order for the system to decide whether and when to carry out the GC operation.

SSDs include a top level controller circuit and a flash (or other semiconductor) memory module. A number of channels, or lanes, are provided to enable communications between the controller and dies within the flash memory. One example is an 8 lane/128 die configuration, with each lane connected to 16 dies. The dies are further subdivided into planes, GCUs, erasure blocks, pages, etc. Groups of dies may be arranged into separate NVMe sets, or namespaces. This allows the various NVMe sets to be concurrently serviced for different owners (users).

SSDs have a limited number of hold up energy after power loss that is tied to the number of capacitors. More capacitors are needed in order to keep a drive alive longer after power loss, minimizing the number of capacitors can increase system performance. On the other hand, limiting the amount of host and metadata that can be written after power loss can restrict the drive performance, since work will need to denied until previously open work has completed. In contrast, the more metadata you can write on power loss improves the time to ready when the drive comes back up again, and less work needs to be done in order to fully reload the drive context.

Data accesses can be tracked with a map structure that describes the physical locations of various data blocks in the system. The map structure may have one or more snapshots of the map that are formed at regular intervals, which can be characterized as “map updates,” as well as journals that show all of the changes that have been made since the most recent map update. An up-to-date map can be formed at any time by taking the most recent map update and merging in the changes reflected in the most recent journal.

As a data map (forward table) is updated by new host writes, journals containing the information in the updates are committed to the flash describing changes. The journals are sequential in nature and each journal can depend on the all the journals written before it. Periodic writes to the memory of the new state of the map supercedes the journals written for the same time period. When a data storage system resumes after power loss, the latest version of the map is loaded into the forward table, and all the journals are read in sequence in order to update the map to the current state of the drive.

An issue arises during data storage system power up when multiple die sets are concurrently vying for mapping information, as well as processing power, from a centralized system location. Such concurrent die set requests for mapping information can slow the time to ready for the data storage systems due to conflicts in map accesses among the die sets and time involved with updating a top-level map with journal updates. For example, a map is loaded during system power up and then the journals are replayed in order to reload all the metadata for the a die set/die/memory/data storage device. If a power loss happened just before the map was going to be written, there could be a large number of journals to replay, which would lengthen the amount of time needed to initialize the data storage system up and make it available to be accessed via one or more hosts.

It is contemplated that a single map structure could be used to describe all of the data stored across all of the different namespaces and die sets of a data storage system. However, this could cause difficulty in negotiating access to the various map units as the different sets are serviced. Similarly, power up initialization could take an extended period of time as mapping information for various different die sets are recreated to the most up-to-date map structure.

Accordingly, embodiments are directed to optimizing data storage system power up by customizing mapping structures to the die set portions of memory. By splitting a top-level map into independent die set maps, each map is written out independently into a corresponding die set, which also means all of the journals are also written independently to corresponding die sets. While each portion of a die set map will have all of associated journals replayed in sequence during power up initialization, all the die set map can be replaying together in parallel. This means that the amount of data for any one die set map is reduced, and the overall time it takes the die set specific journal(s) to fully repopulate the map is reduced.

By maintaining separate map structures for each of the separate die sets in accordance with various embodiments, smaller and more manageable maps can be utilized with each die set having a unique map, reverse directory, and journals. The storage of multiple different map structures in a data storage system allows for customized map updating, such as update frequency and update speed, that are optimized to current, and predicted, data storage system conditions.

During power up initialization, the map data in each die set is updated concurrently by retrieving the most recent map update and merging the most recent journal, which can occur for multiple different die sets of a data storage system in parallel. Adjustments can be made at the rate at which the various map updates are generated to further reduce the time required to bring a die set, and data storage system, to an operationally ready state.

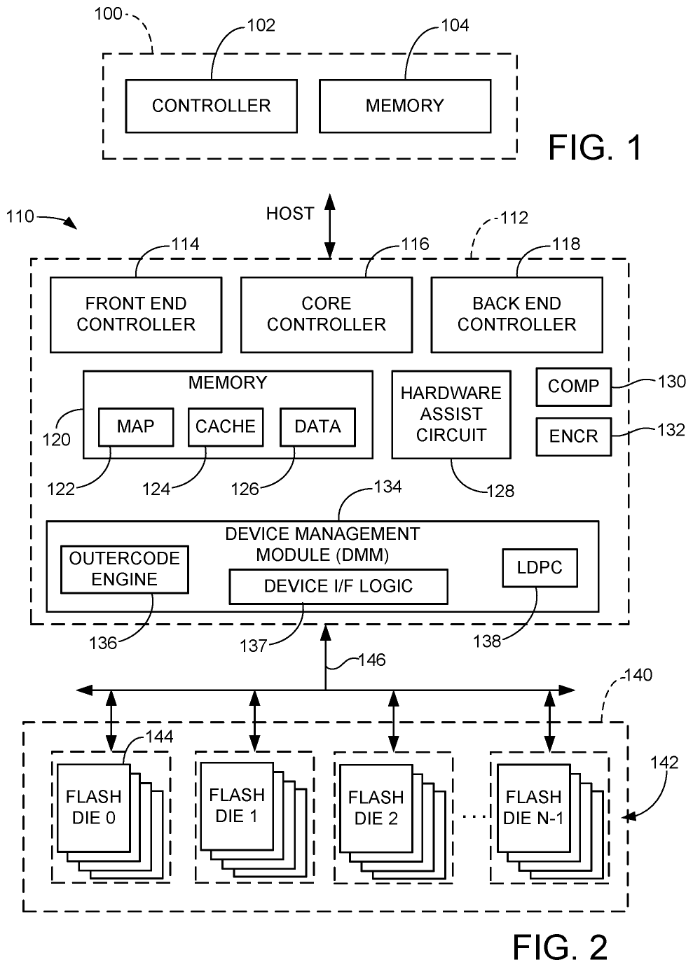

These and other features may be practiced in a variety of different data storage devices, but various embodiments conduct wear range optimization in the example data storage device 100 shown as a simplified block representation in FIG. 1. The device 100 has a controller 102 and a memory module 104. The controller block 102 represents a hardware-based and/or programmable processor-based circuit configured to provide top level communication and control functions. The memory module 104 includes solid state non-volatile memory (NVM) for the storage of user data from one or more host devices 106, such as other data storage devices, network server, network node, or remote controller.

FIG. 2 displays an example data storage device 110 generally corresponding to the device 100 in FIG. 1. The device 110 is configured as a solid state drive (SSD) that communicates with one or more host devices via one or more Peripheral Component Interface Express (PCIe) ports, although other configurations can be used. The NVM is contemplated as comprising NAND flash memory, although other forms of solid state non-volatile memory can be used.

In at least some embodiments, the SSD operates in accordance with the NVMe (Non-Volatile Memory Express) Standard, which enables different users to allocate die sets for use in the storage of data. Each die set may form a portion of a Namespace that may, span multiple SSDs or be contained within a single SSD.

The SSD 110 includes a controller circuit 112 with a front end controller 114, a core controller 116 and a back end controller 118. The front end controller 114 performs host I/F functions, the back end controller 118 directs data transfers with the memory module 114 and the core controller 116 provides top level control for the device.

Each controller 114, 116 and 118 includes a separate programmable processor with associated programming (e.g., firmware, FW) in a suitable memory location, as well as various hardware elements to execute data management and transfer functions. This is merely illustrative of one embodiment; in other embodiments, a single programmable processor (or less/more than three programmable processors) can be configured to carry out each of the front end, core and back end processes using associated FW in a suitable memory location. A pure hardware based controller configuration can also be used. The various controllers may be integrated into a single system on chip (SOC) integrated circuit device, or may be distributed among various discrete devices as required.

A controller memory 120 represents various forms of volatile and/or non-volatile memory (e.g., SRAM, DDR DRAM, flash, etc.) utilized as local memory by the controller 112. Various data structures and data sets may be stored by the memory including one or more map structures 122, one or more caches 124 for map data and other control information, and one or more data buffers 126 for the temporary storage of host (user) data during data transfers.

A non-processor based hardware assist circuit 128 may enable the offloading of certain memory management tasks by one or more of the controllers as required. The hardware circuit 128 does not utilize a programmable processor, but instead uses various forms of hardwired logic circuitry such as application specific integrated circuits (ASICs), gate logic circuits, field programmable gate arrays (FPGAs), etc.

Additional functional blocks can be realized in hardware and/or firmware in the controller 112, such as a data compression block 130 and an encryption block 132. The data compression block 130 applies lossless data compression to input data sets during write operations, and subsequently provides data de-compression during read operations. The encryption block 132 provides any number of cryptographic functions to input data including encryption, hashes, decompression, etc.

A device management module (DMM) 134 supports back end processing operations and may include an outer code engine circuit 136 to generate outer code, a device I/F logic circuit 137 and a low density parity check (LDPC) circuit 138 configured to generate LDPC codes as part of the error detection and correction strategy used to protect the data stored by the by the SSD 110.

A memory module 140 corresponds to the memory 104 in FIG. 1 and includes a non-volatile memory (NVM) in the form of a flash memory 142 distributed across a plural number N of flash memory dies 144. Rudimentary flash memory control electronics (not separately shown in FIG. 2) may be provisioned on each die 144 to facilitate parallel data transfer operations via one or more channels (lanes) 146.

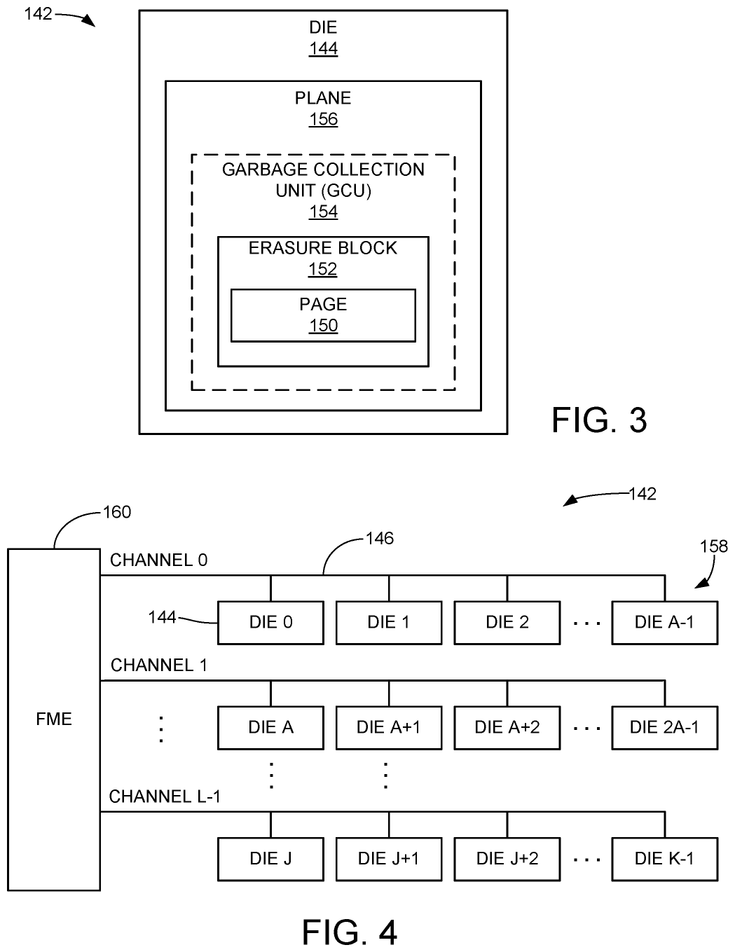

FIG. 3 shows an arrangement of the various flash memory dies 144 in the flash memory 142 of FIG. 2 in some embodiments. Other configurations can be used. The smallest unit of memory that can be accessed at a time is referred to as a page 150. A page may be formed using a number of flash memory cells that share a common word line. The storage size of a page can vary; current generation flash memory pages can store, in some cases, 16 KB (16,384 bytes) of user data.

The memory cells 148 associated with a number of pages are integrated into an erasure block 152, which represents the smallest grouping of memory cells that can be concurrently erased in a NAND flash memory. A number of erasure blocks 152 are turn incorporated into a garbage collection unit (GCU) 154, which are logical structures that utilize erasure blocks that are selected from different dies. GCUs are allocated and erased as a unit. In some embodiments, a GCU may be formed by selecting one or more erasure blocks from each of a population of dies so that the GCU spans the population of dies.

Each die 144 may include a plurality of planes 156. Examples include two planes per die, four planes per die, etc. although other arrangements can be used. Generally, a plane is a subdivision of the die 144 arranged with separate read/write/erase circuitry such that a given type of access operation (such as a write operation, etc.) can be carried out simultaneously by each of the planes to a common page address within the respective planes.

FIG. 4 shows further aspects of the flash memory 142 in some embodiments. A total number K dies 144 are provided and arranged into physical die groups 158. Each die group 158 is connected to a separate channel 146 using a total number of L channels. In one example, K is set to 128 dies, L is set to 8 channels, and each physical die group has 16 dies. As noted above, a single die within each physical die group can be accessed at a time using the associated channel. A flash memory electronics (FME) circuit 160 of the flash memory module 142 controls each of the channels 146 to transfer data to and from the dies 144.

In some embodiments, the various dies are arranged into one or more die sets. A die set represents a portion of the storage capacity of the SSD that is allocated for use by a particular host (user/owner). die sets are usually established with a granularity at the die level, so that some percentage of the total available dies 144 will be allocated for incorporation into a given die set.

A first example die set is denoted at 162 in FIG. 4. This first set 162 uses a single die 144 from each of the different channels 146. This arrangement provides fast performance during the servicing of data transfer commands for the set since all eight channels 146 are used to transfer the associated data. A limitation with this approach is that if the set 162 is being serviced, no other die sets can be serviced during that time interval. While the set 162 only uses a single die from each channel, the set could also be configured to use multiple dies from each channel, such as 16 dies/channel, 32 dies/channel, etc.

A second example die set is denoted at 164 in FIG. 4. This set uses dies 144 from less than all of the available channels 146. This arrangement provides relatively slower overall performance during data transfers as compared to the set 162, since for a given size of data transfer, the data will be transferred using fewer channels. However, this arrangement advantageously allows the SSD to service multiple die sets at the same time, provided the sets do not share the same (e.g., an overlapping) channel 146.

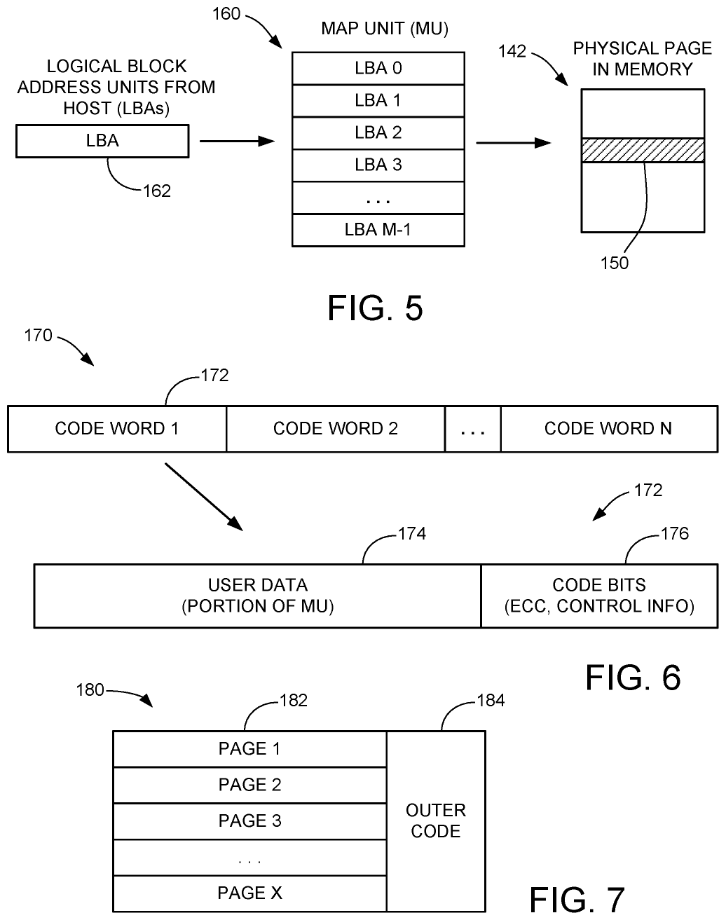

FIG. 5 illustrates a manner in which data may be stored to the flash memory module 142. Map units (MUs) 170 represent fixed sized blocks of data that are made up of one or more user logical block address units (LBAs) 172 supplied by the host. Without limitation, the LBAs 172 may have a first nominal size, such as 512 bytes (B), 1024B (1 KB), etc., and the MUs 170 may have a second nominal size, such as 4096 B (4 KB), etc. The application of data compression may cause each MU to have a smaller size in terms of actual bits written to the flash memory 142.

The MUs 170 are arranged into the aforementioned pages 150 (FIG. 3) which are written to the memory 142. In the present example, using an MU size of 4 KB, then nominally four (4) MUs may be written to each page. Other configurations can be used. To enhance data density, multiple pages worth of data may be written to the same flash memory cells connected to a common control line (e.g., word line) using multi-bit writing techniques; MLCs (multi-level cells) write two bits per cell, TLCs (three-level cells) write three bits per cell; XLCs (four level cells) write four bits per cell, etc.

Data stored by an SSD are often managed using metadata. The metadata provide map structures to track the locations of various data blocks (e.g., MUAs 170) to enable the SSD 110 to locate the physical location of existing data. For example, during the servicing of a read command it is generally necessary to locate the physical address within the flash memory 144 at which the most current version of a requested block (e.g., LBA) is stored, so that the controller can schedule and execute a read operation to return the requested data to the host. During the servicing of a write command, new data are written to a new location, but it is still necessary to locate the previous data blocks sharing the same logical address as the newly written block so that the metadata can be updated to mark the previous version of the block as stale and to provide a forward pointer or other information to indicate the new location for the most current version of the data block.

FIG. 6 shows a functional block diagram for a GCU management circuit 180 of the SSD 110 in accordance with some embodiments. The circuit 180 may form a portion of the controller 112 and may be realized using hardware circuitry and/or one or more programmable processor circuits with associated firmware in memory. The circuit 180 includes the use of a forward map 182 and a reverse directory 184. As noted above, the forward map and reverse directory are metadata data structures that describe the locations of the data blocks in the flash memory 142. During the servicing of host data transfer operations, as well as other operations, the respective portions of these data structures are located in the flash memory or other non-volatile memory location and copied to local memory 120 (see e.g., FIG. 2).

The forward map 182 provides a flash transition layer (FTL) to generally provide a correlation between the logical addresses of various blocks (e.g., MUAs) and the physical addresses at which the various blocks are stored (e.g., die set, die, plane, GCU, EB, page, bit offset, etc.). The contents of the forward map 182 may be stored in specially configured and designated GCUs in each die set.

The reverse directory 184 provides a physical address to logical address correlation. The reverse directory contents may be written as part of the data writing process to each GCU, such as in the form of a header or footer along with the data being written. Generally, the reverse directory provides an updated indication of how many of the data blocks (e.g., MUAs) are valid (e.g., represent the most current version of the associated data).

The circuit 180 further includes a map integrity control circuit 186. As explained below, this control circuit 186 generally operates at selected times to recall and compare, for a given GCU, the forward map data and the reverse directory data. This evaluation step includes processing to determine if both metadata structures indicate the same number and identify of the valid data blocks in the GCU.

If the respective forward map and reverse directory match, the GCU is added to a list of verified GCUs in a data structure referred to as a table of verified GCUs, or TOVG 188. The table can take any suitable form and can include a number of entries, with one entry for each GCU. Each entry can list the GCU as well as other suitable and useful information, such as but not limited to a time stamp at which the evaluation took place, the total number of valid data blocks that were determined to be present at the time of validation, a listing of the actual valid blocks, etc.

Should the control circuit 186 find a mismatch between the forward map 182 and the reverse directory 184 for a given GCU, the control circuit 186 can further operate to perform a detailed evaluation to correct the mismatch. This may include replaying other journals or other data structures to trace the history of those data blocks found to be mismatched. The level of evaluation required will depend on the extent of the mismatch between the respective metadata structures.

For example, if the forward map 182 indicates that there should be some number X valid blocks in the selected GCU, such as 12 valid blocks, but the reverse directory 184 indicates that there are only Y valid blocks, such as 11 valid blocks, and the 11 valid blocks indicated by the reverse directory 184 are indicated as valid by the forward map, then the focus can be upon the remaining one block that is valid according to the forward map but invalid according to the reverse directory. Other mismatch scenarios are envisioned.

The mismatches can arise due to a variety of factors such as incomplete writes, unexpected power surges or disruptions that prevent a full writing of the state of the system, etc. Regardless, the control circuit can expend the resources as available to proactively update the metadata. In some embodiments, an exception list 190 may be formed as a data structure in memory of GCUs that have been found to require further evaluation. In this way, the GCUs can be evaluated later at an appropriate time for resolution, after which the corrected GCUs can be placed on the verified list in the TOVG 188.

It will be noted that the foregoing operation of the control circuit 186 in evaluating GCUs does not take place once a garbage collection operation has been scheduled; instead, this is a proactive operation that is carried out prior to the scheduling of a garbage collection operation. In some cases, GCUs that are approaching the time at which a garbage collection operation may be suitable, such as after the GCU has been filled with data and/or has reached a certain aging limit, etc., may be selected for evaluation on the basis that it can be expected that a garbage collection operation may be necessary in the relatively near future.

FIG. 6 further shows the GCU management circuit 180 to include a garbage collection scheduler circuit 192. This circuit 192 generally operates once it is appropriate to consider performing a garbage collection operation, at which point the circuit 192 selects from among the available verified GCUs from the table 188. In some cases, the circuit 192 may generate a time of completion estimate to complete the garbage collection operation based on the size of the GCU, the amount of data to be relocated, etc.

As will be appreciated, a garbage collection operation can include accessing the forward map and/or reverse directory 182, 184 to identify the still valid data blocks, the reading out and temporary storage of such blocks in a local buffer memory, the writing of the blocks to a new location such as in a different GCU, the application of an erasure operation to erase each of the erasure blocks in the GCU, the updating of program/erase count metadata to indicate the most recent erasure cycle, and the placement of the reset GCU into an allocation pool awaiting subsequent allocation and use for the storage of new data sets.

FIG. 7 shows a number of die sets 200 that may be arranged across the SSD 110 in some embodiments. Each set 200 may have the same nominal data storage capacity (e.g., the same number of allocated dies, etc.), or each may have a different storage capacity. The storage capacity of each die set 200 is arranged into a number of GCUs 154 as shown. In addition, a separate TOVG (table of verified GCUs) 188 may be maintained by and in each die set 200 to show the status of the respective GCUs. From this, each time that it becomes desirable to schedule a garbage collection operation, such as to free up new available memory for a given set, the table 188 can be consulted to select a GCU that, with a high degree of probability, can be subjected to an efficient garbage collection operation without any unexpected delays due to mismatches in the metadata (forward map and reverse directory).

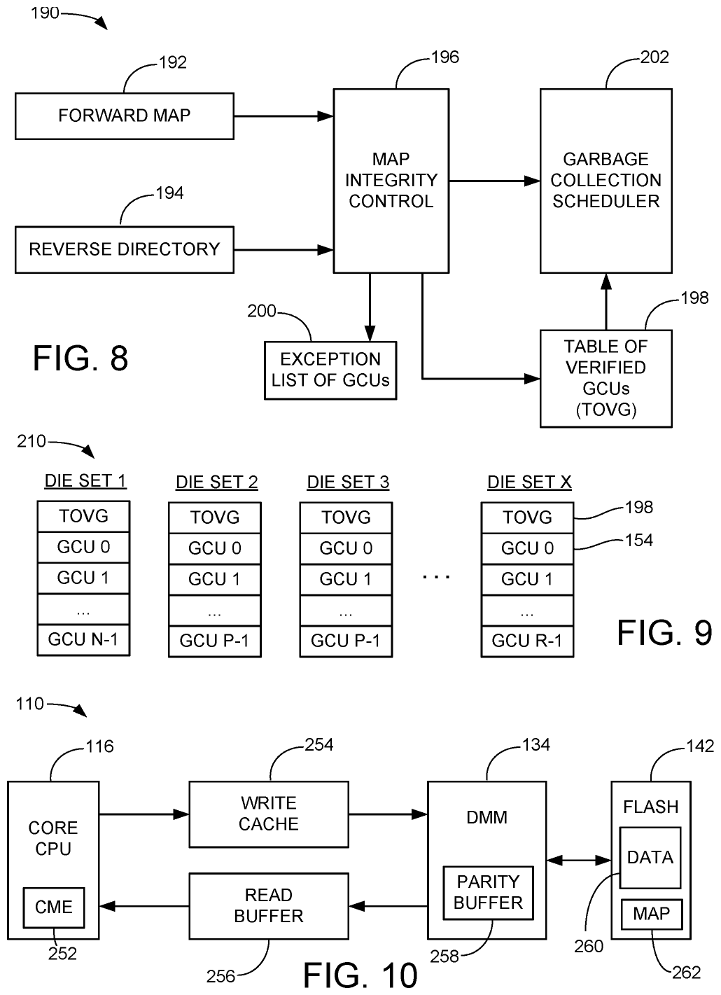

FIG. 8 further shows the GCU management circuit 190 to include a garbage collection scheduler circuit 202. This circuit 202 generally operates once it is appropriate to consider performing a garbage collection operation, at which point the circuit 202 selects from among the available verified GCUs from the table 198. In some cases, the circuit 202 may generate a time of completion estimate to complete the garbage collection operation based on the size of the GCU, the amount of data to be relocated, etc.

As will be appreciated, a garbage collection operation can include accessing the forward map and/or reverse directory 192, 194 to identify the still valid data blocks, the reading out and temporary storage of such blocks in a local buffer memory, the writing of the blocks to a new location such as in a different GCU, the application of an erasure operation to erase each of the erasure blocks in the GCU, the updating of program/erase count metadata to indicate the most recent erasure cycle, and the placement of the reset GCU into an allocation pool awaiting subsequent allocation and use for the storage of new data sets.

FIG. 9 shows a number of die sets 210 that may be arranged across the SSD 110 in some embodiments. Each set 210 may have the same nominal data storage capacity (e.g., the same number of allocated dies, etc.), or each may have a different storage capacity. The storage capacity of each die set 210 is arranged into a number of GCUs 154 as shown. In addition, a separate TOVG (table of verified GCUs) 198 may be maintained by and in each die set 210 to show the status of the respective GCUs. From this, each time that it becomes desirable to schedule a garbage collection operation, such as to free up new available memory for a given set, the table 198 can be consulted to select a GCU that, with a high degree of probability, can be subjected to an efficient garbage collection operation without any unexpected delays due to mismatches in the metadata (forward map and reverse directory).

FIG. 10 shows a functional block representation of additional aspects of the SSD 110. The core CPU 116 from FIG. 2 is shown in conjunction with a code management engine (CME) 212 that can be used to manage the generation of the respective code words and outer code parity values for both standard and non-standard parity data sets

During write operations, input write data from the associated host are received and processed to form MUs 160 (FIG. 3) which are placed into a non-volatile write cache 214 which may be flash memory or other form(s) of non-volatile memory. The MUs are transferred to the DMM circuit 134 for writing to the flash memory 142 in the form of code words 172 as described above. During read operations, one or more pages of data are retrieved to a volatile read buffer 216 for processing prior to transfer to the host.

The CME 212 determines the appropriate inner and outer code rates for the data generated and stored to memory. In some embodiments, the DMM circuit 134 may generate both the inner and outer codes. In other embodiments, the DMM circuit 134 generates the inner codes (see e.g., LDPC circuit 146 in FIG. 2) and the core CPU 116 generates the outer code words. In still other embodiments, the same processor/controller circuit generates both forms of code words. Other arrangements can be used as well. The CME 212 establishes appropriate code rates for both types of code words.

During generation of the outer codes, a parity buffer 218 may be used to successively XOR each payload being written during each pass through the dies. Both payload data 220 and map data 222 will be stored to flash 142.

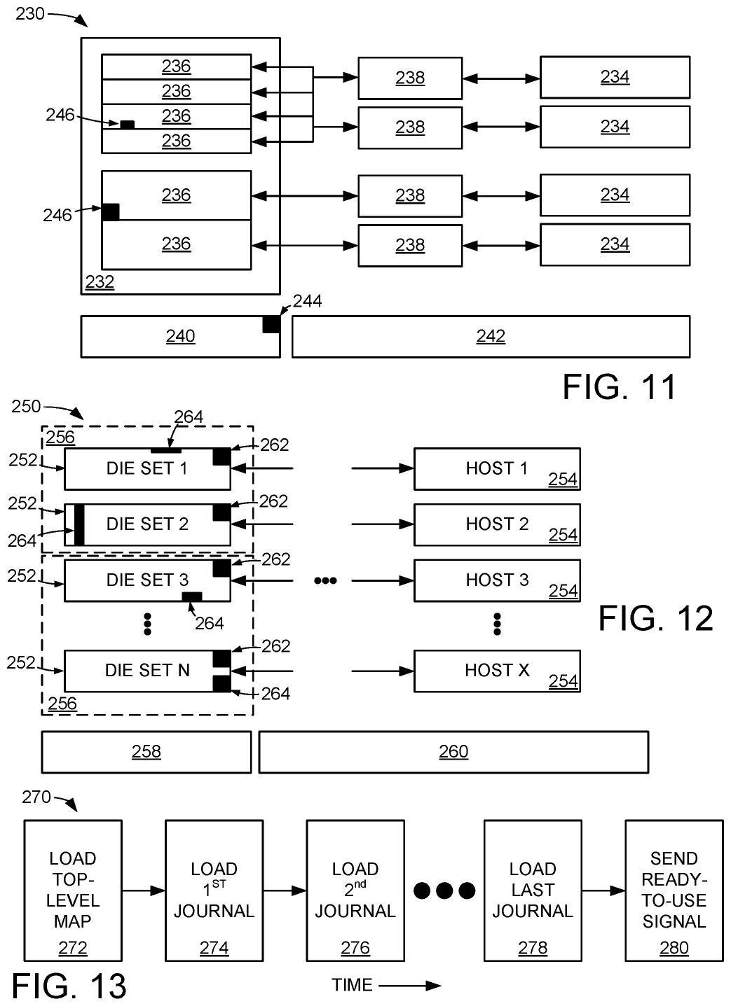

FIG. 11 illustrates a block representation of portions of an example data storage system 230 arranged in accordance with some embodiments. A number of data storage devices 232 can be connected to one remote hosts 234 as part of a distributed network that generates, transfers, and stores data as requested by the respective hosts 234. It is contemplated, but not required, that each remote host 234 is assigned a single logical die set 236, which can be some, or all, of a data storage device 232 memory, such as an entire memory die of a portion of a memory die, like a plane of a memory die. Regardless of the physical configuration of the die sets 236, one or more data queues 238 can be utilized to temporarily store data, and data access commands, awaiting storage in a die set 236 or awaiting delivery from a die set 236.

A local buffer memory 240 can be managed by at least a local controller 242 to store a top-level map 244 that compiles the physical and logical addresses of the data stored in the various die sets 236. As data writes update data in the various die sets 236, the top-level map 244 becomes outdated. The controller 242 can compensate for the top-level map 244 not properly representing the data stored in the data storage system 230 by re-writing the top-level map 244. However, such activity can be time consuming and futile as data writes can be conducted to the die sets 236 as the top-level map 244 is being updated, which immediately results in the top-level map 244 being out-of-date.

It is contemplated that one or more journals 246 can be written to the buffer 240 or to the individual die sets 236 that contain information relating to changes in data. A journal 246, or snapshot, can be physically smaller than the top-level map 244 by containing data access information about less than all the data storage system 230, such as for a single die set 236, and for data accesses over a limited amount of time, such as the most recent minute, hour, or day. As such, many different journals 246 can be generated and stored without updating the top-level map 244. Instead, the top-level map 244 is loaded along with a sequence of journals 246 pertaining to assorted portions of the data storage system 230.

While efficient in writing data access updates, the loading of numerous journals in a specific sequence can be time consuming and processing intensive, which can prolong system time-to-ready upon a power up. In some embodiments, journals 246 and other data access information that can update the top-level map 244 is stored in the die set 236 in which the data updates were experienced. The parallel loading of journals 246 that are stored in such an organized configuration can efficient, but may be plagued with conflicts and delays associated with concurrently loading updates to a single top-level map 244. Accordingly, various embodiments split the top-level map 244 into portions organized for optimal initialization and system time-to-ready.

FIG. 12 depicts portions of another example data storage system 250 in which various embodiments can be practiced. A number (N) of die sets 252 are respectively connected to a number (X) of remote hosts 254 via a distributed network. It is noted that the die sets 252 can be logical divisions of one or more data storage devices/memory die, as generally shown by segmented regions 256.

A local buffer 258 and local controller 260 are available to the data storage system 250 to carry out the assorted data access requested by the hosts 254 and corresponding background operations triggered by the execution of those data access requests. One such background operation can be the maintenance of a die set map structure that corresponds with a single die set 252. As shown, a die set 252 can have a top-level map 262 that compiles the logical and physical addresses of the various host data stored in the die set 252 in which the map 262 is stored and a journal 264 that pertains to data access updates to the top-level map 262.

It is contemplated that a die set 252 has numerous different journals 264 generated and stored by the local controller 260 as needed. At some time, the controller 260 can direct garbage collection activity of the various journals 264 of a die set 252 where the data update information of the journals 264 is incorporated into the die set top-level map 262 prior to the journals 264 being erased.

The separate map structures of the respective die sets 252 can consume more initial system resources, such as processing power, time, and electrical power, than the unseparated journals 246 and top-level map 244 of system 230, but the separation of journals 264 and maps 262 by die set 252 allows for optimal system time-to-ready with minimal data conflicts and maximum journal loading through parallel journal execution in the respective die sets 252 of the data storage system 250.

FIG. 13 provides a block representation of an example die set initialization process 270 that can occur during a power cycle to the data storage system 250 of FIG. 12. Although the initialization process 270 corresponds with a single die set initialization, it is noted that numerous other die sets of a data storage system can also execute the initialization process 270. For instance, a system controller can direct multiple different die sets to concurrently execute the initialization process 270. In other embodiments, a system controller can stagger the initialization process of different die sets so that some die sets become ready for data access earlier than other die sets of the data storage system.

Upon a power down situation in which operation of a data storage system ceases, each logical die set will have a map structure stored in the die set and pertaining only to data stored in that die set. The map structure may consist of as little as a top-level map, but it is expected that at least one journal will also be present. The top-level map for at least one die set is loaded in step 272 in response to power being provided to a system controller and the die set so that the information of the top-level map can be accessed. The top-level map loaded in step 272 may be stored anywhere in a data storage system, but is located at a physical block address, in some embodiments, that corresponds with the range of logical block addresses of the logical die set that the top-level map is mapping.

While the top-level map may be current and a complete, accurate depiction of the user-generated data stored in the logical die set, it is contemplated that at least some user-generated data has been updated so that some die set data is out-of-date. Periodic updates to the top-level map can be stored as journals in the logical die set in which the user-generated data updates have taken place. Step 274 loads a first journal update to the top-level map prior to a second journal update being loaded in step 276. Any number of journals can subsequently be loaded until a last journal update is loaded in step 278. It is noted that the journal entries are sequential and may provide user-generated data location information that can only be accurately mapped by loading the journals in the order in which the journals were generated.

Once the top-level map has been supplemented by the journal entries corresponding with the logical die set, step 280 proceeds to broadcast a ready-for-use signal that corresponds with the execution of the first host data access command pending in a die set queue. The die set initialization process 270 can be considered complete at step 280 as the die set proceeds to engage data access and background data operations as directed by a host, local controller, and queue. It is contemplated that the loading of the various journals can, in some embodiments, be loaded at different rates and/or frequencies to provide control and congruency with other die sets of a data storage system. That is, a local controller can delay loading a journal for any reason, such as to prioritize the loading of journals and initializing die sets of a system involved with bringing the system to a ready state, which can decrease system startup time and time-to-ready.

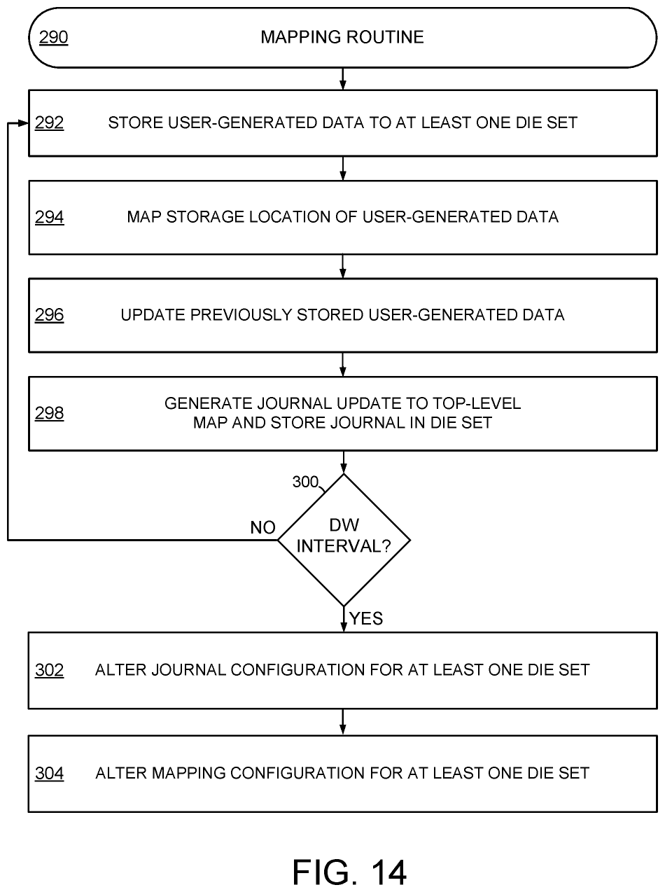

The initialization process 270 of FIG. 13 can be practiced as part of the overall mapping routine 290 conveyed in FIG. 14. User-generated data is stored in at least one die set of a data storage system in step 292 as directed by host initiated data access commands and executed by a local system controller. The storage location of the user-generated data is mapped in step 294 with the map being subsequently stored in the die set in which the user-generated data is stored.

An update to the user-generated data stored in step 296 prompts a journal to be generated and written to the die set in which the user-generated data is stored in step 298. It is contemplated that step 298 rewrites the top-level map generated in step 294 instead of creating a journal comprising less than all the mapping information of the top-level map. However, many situations are more conducive to generating a physically smaller journal snapshot of an update to a relatively small number of user-generated data updates compared to the rewriting the top-level map data for all user-generated data of a die set.

Routine 290 can evaluate if a die set is currently, or will immediately be engaged in, a DW interval where data access performance consistency is emphasized over data access peak performance. If a DW interval is in play, step 292 alters the journaling configuration of at least one die set of a data storage device in order to focus processing and electrical power to the die set entering, and enduring, the DW interval. For example, a local controller can alter the journaling rate, size, or initial storage location of a generated journal to get a die set marked for a DW interval ready for data accesses faster than other die sets of the data storage system. Hence, journal mapping and loading can be customized to optimize a die set's time-to-ready during initialization when a DW interval is imminent.

A mapping configuration/procedure for any die set of a data storage system can also be adapted in step 294 during a DW interval to increase data access consistency to the die set in the DW interval. Although not required or limiting, step 294 can delay journaling, store smaller journals, and temporarily write journals to different, NDW interval die sets to decrease variability in data access performance for the die set involved in the DW interval. The ability to alter journaling configuration, such as storing journals in a buffer or speeding up the generation of smaller journals during DW intervals compared to NDW intervals, allows for customization of mapping procedure to optimize I/O deterministic operation of a data storage system.

Through the various embodiments of the initialization process 270 and mapping routine 290, a data storage system can enjoy optimized power up initialization and I/O determinism operation. By storing a top-level map and any subsequent journals in the die set in which the map/journals pertain, map data is condensed compared to having an overall top-level system map, which allows for faster loading and execution of a map structure for a die set during power up initialization. The potential to adapt mapping configurations for individual die sets during power up initialization and/or DW interval operation allows for faster and more efficient handling of user-generated data updates than having an overall map structure involving data from multiple different die sets of a data storage system.

What is claimed is:

1. A method comprising:
dividing a semiconductor memory into a first die set and a second die set;
storing a first user-generated data to the first die set;
logging the first user-generated data in a first top-level map stored in the first die set;
updating the first user-generated data; and
storing a first journal to the first top-level map in the first die set, the first journal supplementing the first top-level map with information about the updated first user-generated data.

2. The method of claim 1, wherein the second die set comprises a second user-generated data.

3. The method of claim 2, wherein a second top-level map is stored in the second die set, the second top-level map comprising information about the second user-generated data.

4. The method of claim 3, wherein the second top-level map is unique from the first top-level map.

5. The method of claim 3, wherein a second journal is stored in the second die set

6. The method of claim 1, wherein the first top-level map contains information only about user-generated data stored in the first die set.

7. The method of claim 3, wherein the second top-level map contains information only about user-generated data stored in the second die set.

8. The method of claim 5, wherein a third journal is stored in the second die set, the third journal comprising an update to the second top-level map.

9. The method of claim 8, wherein the second journal is unique from the third journal.

10. A method comprising:
dividing a semiconductor memory into a plurality of die sets;
storing a top-level map in each of the plurality of die sets, each top-level map logging information about user-generated data stored in a die set in which the top-level map is stored; and
storing a journal in at least one die set of the plurality of die sets, each journal logging a change to user-generated data stored in a die set of the plurality of die sets in which the journal and top-level map are each located.

11. The method of claim 10, wherein each die set of the plurality of die sets is assigned to a different host.

12. The method of claim 10, wherein the top-level map for each of the plurality of die sets are loaded by a controller concurrently during a power up initialization.

13. The method of claim 12, wherein the journal is loaded immediately after the top-level map for at least one die set of the plurality of die sets.

14. The method of claim 10, wherein a journal configuration for at least one of the plurality of die sets is altered by a controller in response to a deterministic window interval.

15. The method of claim 10, wherein a mapping configuration for at least one of the plurality of die sets is altered by a controller in response to a deterministic window interval.

16. The method of claim 15, wherein the mapping configuration is altered by changing a location of the top-level map during the deterministic window interval.

17. The method of claim 14, wherein the journal configuration is altered by changing a rate at which a journal is generated.

18. The method of claim 10, wherein the user-generated data is provided to the semiconductor memory by a remote host.

19. A system comprising a semiconductor memory into a plurality of die sets, each of the plurality of die sets storing a top-level map logging information about user-generated data stored in a die set in which the top-level map is stored, at least one die set of the plurality of die sets comprising a journal logging a change to user-generated data stored in a die set of the plurality of die sets in which the journal and top-level map are each located.

20. The system of claim 19, wherein each die set of the plurality of die sets comprises an independent top-level map and each journal is unique to user-generated data stored in the die set of the plurality of die sets in which the journal and top-level map are each located
